(19) United States
(12) Patent Application Publication
(10) Pub. No.: US 2016/0053938 A1
(43) Pub. Date: Feb. 25, 2016

(54) Hat Holding Device

(71) Applicant: Kevin Snustead, Torrance, CA (US)

(72) Inventor: Kevin Snustead, Torrance, CA (US)

(21) Appl. No.: 14/824,517

(22) Filed: Aug. 12, 2015

Related U.S. Application Data
(60) Provisional application No. 62/038,951, filed on Aug. 19, 2014.

(51) Int. Cl. F16M 13/02; F16B 1/00; A47G 29/00; F16B 2/22; A47B 61/04; F16B 47/00; F16B 45/00

(52) U.S. Cl. CPC F16M 13/022; F16B 47/00; F16B 1/00; F16B 45/00; F16B 2/22; A47B 61/04; A47G 29/00; F16B 2001/0035

(57) ABSTRACT

A hat holding device for removably securing a baseball cap thereon. The hat holding device includes a suction cup and an ornamental member that can be removably attached to the suction cup. The ornamental member can have various configurations, and may resemble a baseball, an animal head, a helmet, or various other decorative objects. The ornamental member includes a clip or hook thereon for securing the brim of a hat. The clip or hook extends from the lower end of the ornamental member and allows the hat to be suspended in a horizontal orientation. Thus, the present invention provides a hat holding device having a customizable and ornamental appearance that can be secured to a windshield, window, or other surface by means of the suction cup thereon.

### CROSS REFERENCE TO RELATED APPLICATION

This application claims the benefit of U.S. Provisional Application No. 62/038,951 filed on Aug. 19, 2014. The above identified patent application is herein incorporated by reference in its entirety to provide continuity of disclosure.

### BACKGROUND OF THE INVENTION

1. Field of the Invention

The present invention relates to a hat holding device. More specifically, the present invention provides a hat holding device having a suction cup for securement to a windshield or window, an ornamental member having any of various appearances, and a clip or hook affixed to the underside or lower end of the ornamental member for securing the brim of a hat thereon.

Many people wear baseball hats having a specific logo or emblem thereon so that the person can show their support for a particular school, sports team, society, or brand. People even use hats and other memorabilia as decorations in their home, on their vehicles, and in their offices. However, hats are not easily displayed and can be difficult to support in a way that allows the logo or emblem thereon to be visible.

In order to display a hat, people may install a hook on a wall or other support surface. However, installing a hook can be time consuming and causes damage to the wall. Further, a hook cannot be installed in a vehicle, which makes it difficult for a person to display a hat within a vehicle. Thus, a hat holding device that can be removably secured to a wall, window, or other support surface without causing damage thereto is desired.

2. Description of the Prior Art

Devices have been disclosed in the prior art that relate to hat holding devices. These include devices that have been patented and published in patent application publications. These devices generally relate to suction cup devices having fasteners or clamps for securing various objects thereon. The following is a list of devices deemed most relevant to the present disclosure, which are herein described for the purposes of highlighting and differentiating the unique aspects of the present invention, and further highlighting the drawbacks existing in the prior art.

Patents in the prior art relate to suction cup devices for securement to a window and that include various clips, brackets, and other fasteners thereon for securing objects, such as U.S. Pat. No. 6,799,756, U.S. Pat. No. 7,651,063, U.S. Pat. No. 4,991,806, and U.S. Pat. No. 5,595,364. Other devices provide means for securing objects to a window, such as U.S. Pat. No. 8,596,331.

These prior art devices have several known drawbacks. The devices in the prior art fail to disclose a hat holding device adapted to support a baseball cap in a horizontal orientation. The devices further fail to disclose an interchangeable ornamental member that resembles a decorative object, such as a baseball, an animal head, or various other ornamental objects.

In light of the devices disclosed in the prior art, it is submitted that the present invention substantially diverges in design elements from the prior art and consequently it is clear that there is a need in the art for an improvement to existing hat holding devices. In this regard the instant invention substantially fulfills these needs.

### SUMMARY OF THE INVENTION

In view of the foregoing disadvantages inherent in the known types of hat holding devices now present in the prior art, the present invention provides a new hat holding device wherein the same can be utilized for providing convenience for the user when displaying a hat on a windshield, window, or other support surface.

It is therefore an object of the present invention to provide a new and improved hat holding device that has all of the advantages of the prior art and none of the disadvantages.

It is another object of the present invention to provide a hat holding device having a suction cup, an ornamental member removably securable to the suction cup, and a clip or fastener disposed on the ornamental member for securing the brim of a hat.

Another object of the present invention is to provide a hat holding device having an ornamental member that can resemble any of various objects such as a baseball, a helmet, or an animal head, among others.

Yet another object of the present invention is to provide a hat holding device adapted to support a hat in a horizontal orientation such that the logo or emblem thereon is easily visible.

Another object of the present invention is to provide a hat holding device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of the hat holding device of the present invention.

FIG. 2 shows a perspective view of the hat holding device of the present invention with the ornamental member removed therefrom.

FIG. 3 shows a perspective view of the hat holding device in use.

### DETAILED DESCRIPTION OF THE INVENTION

Reference is made herein to the attached drawings. Like reference numerals are used throughout the drawings to depict like or similar elements of the hat holding device of the present invention. For the purposes of presenting a brief and clear description of the present invention, the preferred embodiment will be discussed as used for holding a hat in a horizontal orientation to display the logo or emblem thereon. The figures are intended for representative purposes only and should not be considered to be limiting in any respect.

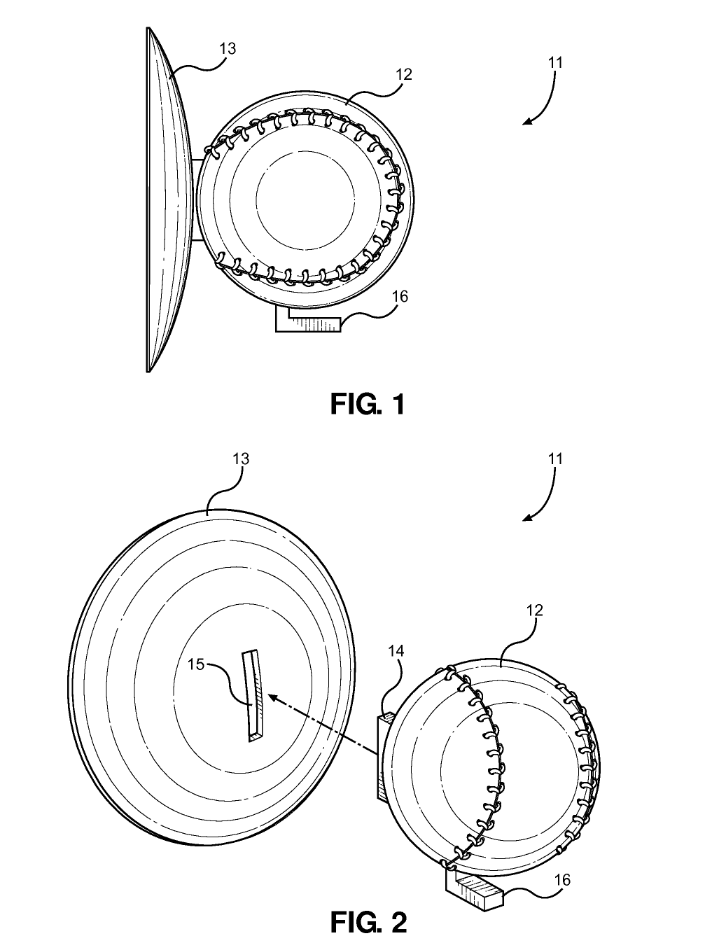

Referring now to FIG. 1, there is shown a side view of the hat holding device of the present invention. The hat holding device 11 includes a suction cup 13 adapted to be secured to a support surface, such as a vehicle windshield, a window, a mirror, or a wall, among others. An ornamental member 12 is removably securable to the suction cup 13 via mating fasteners. The ornamental member 12 can have any of various appearances so as to resemble decorative objects. Further, the ornamental member 12 includes a clip or hook 16 on a lower end or on the underside thereof. The clip or hook 16 is adapted to hold a hat in a horizontal orientation, and is preferably used to secure the brim of a hat.

The ornamental member 12 can be provided so as to resemble various different decorative objects. The ornamental member 12 can resemble a sports ball such as a baseball, a tennis ball, a football, or a basketball, among others. Further, the ornamental member 12 can resemble a helmet, such as a football helmet or a baseball helmet. In other embodiments, the ornamental member 12 resembles a mask. Alternatively, the ornamental member 12 can resemble an animal head. Thus, the ornamental member 12 can resemble any of various decorative objects including but not limited to the above mentioned objects.

A fastener 16 is secured to the lower end or underside of the ornamental member 12. The fastener may be permanently or removably attached to the ornamental member 12, and the fastener preferably comprises a clip or a hook. The fastener 16 includes a first section that extends downward from the ornamental member 12, and a second section that extends in a horizontal orientation perpendicular to the first section. The second section is spaced from the underside of the ornamental member 12 so that the brim of a hat can be received between the second section of the fastener and the lower surface of the ornamental member 12. In this way, the hat can be secured in a horizontal orientation such that the logo or emblem thereon faces towards the ornamental member 12. Alternatively, the fastener 16 may include a clip having upper and lower member pivotally affixed to one another and spring-biased in a closed configuration so that the brim of a hat can be positioned therebetween. Again, the clip is adapted to support the hat in a horizontal orientation so that the display faces towards the ornamental member thereon. In some embodiments, the fastener 16 may be removably securable to the ornamental member and may be secured thereon via a threaded engagement or a press fit.

Referring now to FIG. 2, there is shown a perspective view of the hat holding device of the present invention with the ornamental member removed therefrom. The suction cup 13 includes a fastener 15 thereon for securement to a fastener 14 of the ornamental member 12, thus the fasteners 14, 15 are adapted to mate with one another. The fastener 15 on the suction cup 13 may include a recessed area, and the fastener 14 of the ornamental member 12 may include a protrusion adapted to be removably inserted into the recessed area. In this way, the ornamental member 12 can be secured to the suction cup 13 via a press fit or snap fit. In alternate embodiments, the fastener 15 on the suction cup 13 may include a magnet that engages with a magnet or magnetic surface of the ornamental member 12. Other suitable fasteners may be used to removably secure the ornamental member 12 to the suction cup 13 of the present invention.

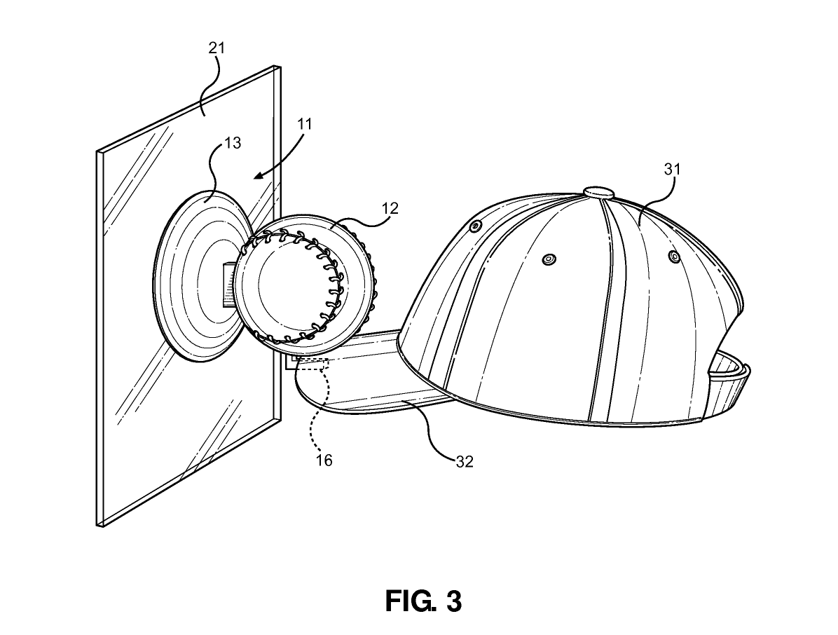

Referring now to FIG. 3, there is shown a perspective view of the hat holding device in use. The suction cup 13 can be removably secured to a support surface 21 such as a windshield of a vehicle. The user can select an ornamental member 12 and can secure it to the suction cup 13 via the fasteners thereon. The hook or clip 16 extends from the lower end of the ornamental member 12 and can be used to hold the brim 32 of a hat 31 such that the hat 31 is in a horizontal orientation. In this way, when the device is used on a vehicle windshield, the emblem or logo on the hat is visible from the exterior of the vehicle.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A hat holding device, comprising:
a suction cup;
an ornamental member removably securable to said suction cup;
a hat fastener disposed on said ornamental member and adapted to secure a brim of a hat so as to hold said hat in a horizontal orientation.

2) The hat holding device of claim 1, wherein said ornamental member is removably securable to said suction cup via mating fasteners, wherein a first fastener is disposed on said suction cup and a second fastener is disposed on said ornamental member.

3) The hat holding device of claim 2, wherein said first fastener comprises a recessed area and wherein said second fastener comprises a protrusion adapted to fit within said recessed area, securing said ornamental member to said suction cup via press fit.

4) The hat holding device of claim 1, wherein said ornamental member is removably securable to said suction cup via a magnetic engagement.

5) The hat holding device of claim 1, wherein said ornamental member resembles a sports ball.

6) The hat holding device of claim 1, wherein said ornamental member comprises an animal head.

7) The hat holding device of claim 1, wherein said hat fastener comprises an L-shaped hook.

8) The hat holding device of claim 1, wherein said hat fastener comprises a clip.

9) The hat holding device of claim 1, wherein said hat fastener is affixed to a lower end of said ornamental member.

10) The hat holding device of claim 1, wherein said hat fastener is removably secured to said ornamental member.
